(19) United States
(12) Patent Application Publication
(10) Pub. No.: US 2006/0095894 A1
(43) Pub. Date: May 4, 2006

(54) Method and apparatus to provide graphical architecture design for a network processor having multiple processing elements

(76) Inventors: Myles J. Wilde, Charlestown, MA (US); Ron Rocheleau, Hopkinton, MA (US)

Correspondence Address: Daly, Crowley & Mofford, LLP;c/o PortfolioIP, P.O. Box 52050, Minneapolis, MN, 55402, US

(21) Appl. No.: 10/941,627

(22) Filed: Sep. 15, 2004

(51) Int. Cl. G06F 9/44

(52) U.S. Cl. 717/113

(57) ABSTRACT

An architecture development tool enables a user to graphically design an application for processor system having a plurality of processing elements.

### CROSS REFERENCE TO RELATED APPLICATIONS

Not Applicable.

### STATEMENT REGARDING FEDERALLY SPONSORED RESEARCH

Not Applicable.

### BACKGROUND

As is known in the art, developing code for multi-processor, multi-threaded systems, such as the IXP2XXX Network Processor Product Line from Intel Corporation, is challenging. Network processors belonging to the IXP2XXX Network Processor Product Line contain multiple processing engines, each having multiple hardware threads to perform multiple tasks, such as packet processing, in parallel. Designing application software for such a system can be relatively complex.

### BRIEF DESCRIPTION OF THE DRAWINGS

The exemplary embodiments will be more fully understood from the following detailed description taken in conjunction with the accompanying drawings, in which:

FIG. 1 is a block diagram of a processor having processing elements that support multiple threads of execution;

FIG. 2 is a block diagram of an exemplary processing element (PE) that runs microcode;

FIG. 3 is a depiction of some local Control and Status Registers (CSRs) of the PE of FIG. 2;

FIG. 4 is a diagram showing pipeline drawings, task drawings and performance evaluations for an architecture development tool;

FIG. 5 is a graphical representation showing an exemplary task;

FIG. 5A is an exemplary graphical user interface to define a code block;

FIG. 5B is an exemplary graphical user interface to define an I/O reference;

FIG. 6 is a graphical representation of an processing pipeline;

FIG. 7 is a pictorial representation of a design using an architecture development tool;

FIG. 8 is a pictorial representation of a data structure user interface;

FIG. 8A is a pictorial representation of a buffer pool under interface;

FIG. 8B is a pictorial representation of a data buffer calculator;

FIG. 9 is a pictorial representation of a generic data structure interface;

FIG. 10 is a pictorial representation of a ring data structure interface;

FIG. 11 is a tabular representation of exemplary objects;

FIG. 12 is a visual representation of a task;

FIG. 13 is a pictorial representation of an I/O reference property interface;

FIG. 14 is a pictorial representation of a next neighbor property interface;

FIG. 15 is a pictorial representation of a code block property interface;

FIG. 16 is a block diagram of a functional pipeline and a context pipeline;

FIG. 17 is a pictorial representation of a SRAM chip configuration interface;

FIG. 17A is a pictorial representation of a DRAM chip configuration interface;

FIG. 17B is a pictorial representation of a MSF chip configuration interface;

FIG. 17C is a pictorial representation of a clock chip configuration interface;

FIG. 18 is a pictorial representation of a media overhead and data rate interface;

FIG. 19 is a flow diagram showing exemplary processing for an architecture development tool;

FIG. 20 is a schematic depiction of an exemplary system having an architecture development tool that can be used to generate microcode for the PE shown in FIG. 2;

FIG. 21 is a block diagram illustrating the various components of the system of FIG. 20;

FIG. 22 is a schematic representation of an exemplary computer system suited to run an architecture development tool; and

FIG. 23 is a diagram of a network forwarding device.

### DETAILED DESCRIPTION

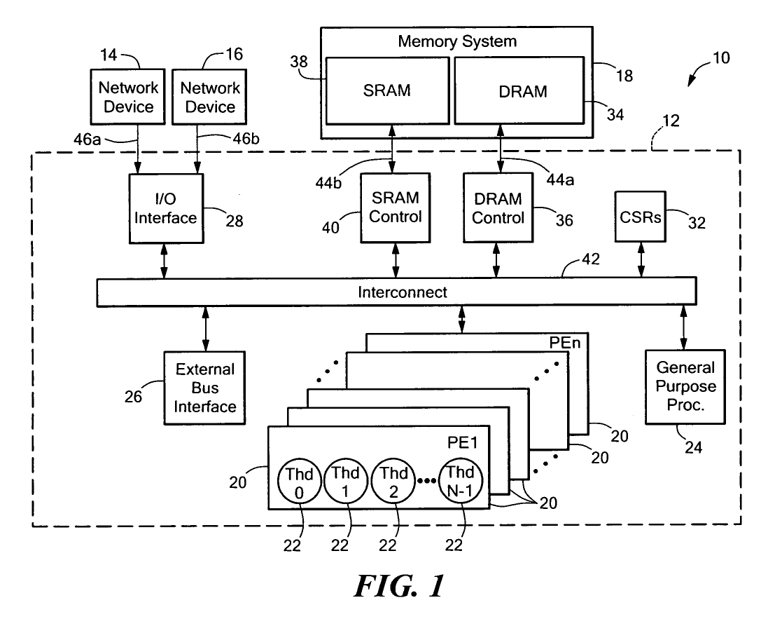

FIG. 1 shows a system 10 including a processor 12 for which a graphical architecture development system can be used to develop and evaluate code. The processor 12 is coupled to one or more I/O devices, for example, network devices 14 and 16, as well as a memory system 18. The processor 12 includes multiple processors (“processing engines” or “PEs”) 20, each with multiple hardware controlled execution threads 22. In the example shown, there are “n” processing elements 20, and each of the processing elements 20 is capable of processing multiple threads 22, as will be described more fully below. In the described embodiment, the maximum number “N” of threads supported by the hardware is eight. Each of the processing elements 20 is connected to and can communicate with adjacent processing elements.

In one embodiment, the processor 12 also includes a general-purpose processor 24 that assists in loading microcode control for the processing elements 20 and other resources of the processor 12, and performs other computer type functions such as handling protocols and exceptions. In network processing applications, the processor 24 can also provide support for higher layer network processing tasks that cannot be handled by the processing elements 20.

The processing elements 20 each operate with shared resources including, for example, the memory system 18, an external bus interface 26, an I/O interface 28 and Control and Status Registers (CSRs) 32. The I/O interface 28 is responsible for controlling and interfacing the processor 12 to the I/O devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, storing buffer descriptors and free buffer lists, and so forth.

The devices 14, 16 can be any network devices capable of transmitting and/or receiving network traffic data, such as framing/MAC devices, e.g., for connecting to 10/100BaseT Ethernet, Gigabit Ethernet, ATM or other types of networks, or devices for connecting to a switch fabric. For example, in one arrangement, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The I/O interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The I/O interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also be serviced by the processor 12.

In general, as a network processor, the processor 12 can interface to various types of communication devices or interfaces that receive/send data. The processor 12 functioning as a network processor could receive units of information from a network device like network device 14 and process those units in a parallel manner. The unit of information could include an entire network packet (e.g., Ethernet packet) or a portion of such a packet, e.g., a cell such as a Common Switch Interface (or “CSIX”) cell or ATM cell, or packet segment. Other units are contemplated as well.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The I/O Interface 28 is coupled to the devices 14 and 16 via separate I/O bus lines 46a and 46b, respectively.

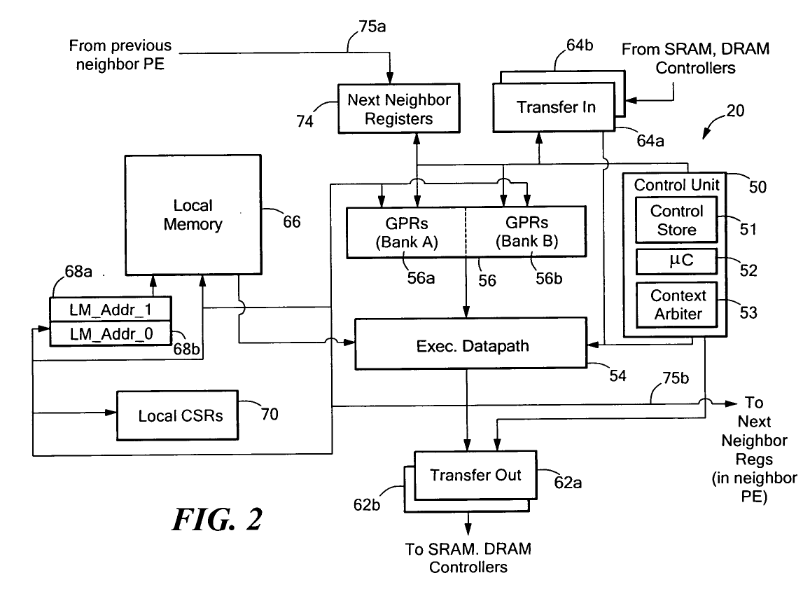

Referring to FIG. 2, an exemplary one of the processing elements 20 is shown. The processing element (PE) 20 includes a control unit 50 that includes a control store 51, control logic (or microcontroller) 52 and a context arbiter/event logic 53. The control store 51 is used to store microcode. The microcode is loadable by the processor 24. The functionality of the PE threads 22 is therefore determined by the microcode loaded via the core processor 24 for a particular user's application into the processing element's control store 51.

The microcontroller 52 includes an instruction decoder and program counter (PC) unit for each of the supported threads. The context arbiter/event logic 53 can receive messages from any of the shared resources, e.g., SRAM 38, DRAM 34, or processor core 24, and so forth. These messages provide information on whether a requested function has been completed.

The PE 20 also includes an execution datapath 54 and a general purpose register (GPR) file unit 56 that is coupled to the control unit 50. The datapath 54 may include a number of different datapath elements, e.g., an ALU, a multiplier and a Content Addressable Memory (CAM).

The registers of the GPR file unit 56 (GPRs) are provided in two separate banks, bank A 56a and bank B 56b. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The PE 20 further includes write transfer (transfer out) register file 62 and a read transfer (transfer in) register file 64. The write transfer registers of the write transfer register file 62 store data to be written to a resource external to the processing element. In the illustrated embodiment, the write transfer register file is partitioned into separate register files for SRAM (SRAM write transfer registers 62a) and DRAM (DRAM write transfer registers 62b). The read transfer register file 64 is used for storing return data from a resource external to the processing element 20. Like the write transfer register file, the read transfer register file is divided into separate register files for SRAM and DRAM, register files 64a and 64b, respectively. The transfer register files 62, 64 are connected to the datapath 54, as well as the control store 50. It should be noted that the architecture of the processor 12 supports “reflector” instructions that allow any PE to access the transfer registers of any other PE.

Also included in the PE 20 is a local memory 66. The local memory 66 is addressed by registers 68a (“LM_Addr_{—}1”), 68b (“LM_Addr_{—}0”), which supplies operands to the datapath 54, and receives results from the datapath 54 as a destination.

The PE 20 also includes local control and status registers (CSRs) 70, coupled to the transfer registers, for storing local inter-thread and global event signaling information, as well as other control and status information. Other storage and functions units, for example, a Cyclic Redundancy Check (CRC) unit (not shown), may be included in the processing element as well.

Other register types of the PE 20 include next neighbor (NN) registers 74, coupled to the control store 50 and the execution datapath 54, for storing information received from a previous neighbor PE (“upstream PE”) in pipeline processing over a next neighbor input signal 76a, or from the same PE, as controlled by information in the local CSRs 70. A next neighbor output signal 76b to a next neighbor PE (“downstream PE”) in a processing pipeline can be provided under the control of the local CSRs 70. Thus, a thread on any PE can signal a thread on the next PE via the next neighbor signaling.

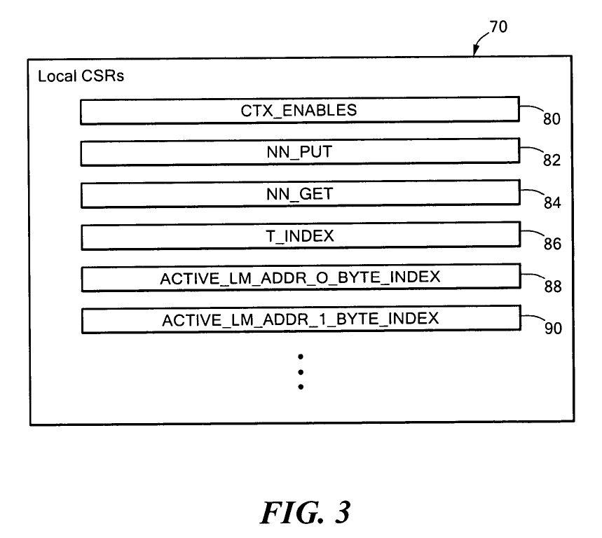

Generally, the local CSRs 70 are used to maintain context state information and inter-thread signaling information. Referring to FIG. 3, registers in the local CSRs 70 may include the following: CTX_ENABLES 80; NN_PUT 82; NN_GET 84; T_INDEX 86; ACTIVE_LM ADDR_{—}0_BYTE_INDEX 88; and ACTIVE_LM ADDR_{—}1_BYTE_INDEX 90. The CTX_ENABLES register 80 specifies, among other information, the number of contexts in use (which determines GPR and transfer register allocation) and which contexts are enabled. It also controls how NN mode, that is, how the NN registers in the PE are written (NN_MODE=‘0’ meaning that the NN registers are written by a previous neighbor PE, NN_MODE=‘1’ meaning the NN registers are written from the current PE to itself). The NN_PUT register 82 contains the “put” pointer used to specify the register number of the NN register that is written using indexing. The NN_GET register 84 contains the “get” pointer used to specify the register number of the NN register that is read when using indexing. The T_INDEX register 86 provides a pointer to the register number of the transfer register (that is, the S_TRANSFER register 62a or D_TRANSFER register 62b) that is accessed via indexed mode, which is specified in the source and destination fields of the instruction. The ACTIVE_LM ADDR_{—}0_BYTE_INDEX 88 and ACTIVE_LM ADDR_{—}1_BYTE_INDEX 90 provide pointers to the number of the location in local memory that is read or written. Reading and writing the ACTIVE_LM_ADDR_x_BYTE_INDEX register reads and writes both the corresponding LM_ADDR_x register and BYTE INDEX registers (also in the local CSRs).

In the illustrated embodiment, the GPR, transfer and NN registers are provided in banks of 128 registers. The hardware allocates an equal portion of the total register set to each PE thread. The 256 GPRs per-PE can be accessed in thread-local (relative) or absolute mode. In relative mode, each thread accesses a unique set of GPRs (e.g., a set of 16 registers in each bank if the PE is configured for 8 threads). In absolute mode, a GPR is accessible by any thread on the PE. The mode that is used is determined at compile (or assembly) time by the programmer. The transfer registers, like the GPRs, can be assessed in relative mode or in absolute-mode. If accessed globally in absolute mode, they are accessed indirectly through an index register, the T_INDEX register. The T_INDEX is loaded with the transfer register number to access.

As discussed earlier, the NN registers can be used in one or two modes, the “neighbor” and “self” modes (configured using the NN_MODE bit in the CTX_ENABLES CSR). The “neighbor” mode makes data written to the NN registers available in the NN registers of a next (adjacent) downstream PE. In the “self” mode, the NN registers are used as extra GPRs. That is, data written into the NN registers is read back by the same PE. The NN_GET and NN_PUT registers allow the code to treat the NN registers as a queue when they are configured in the “neighbor” mode. The NN_GET and NN_PUT CSRs can be used as the consumer and producer indexes or pointers into the array of NN registers.

At any given time, each of the threads (or contexts) of a given PE is in one of four states: inactive; executing; ready and sleep. At most one thread can be in the executing state at a time. A thread on a multi-threaded processor such as PE 20 can issue an instruction and then swap out, allowing another thread within the same PE to run. While one thread is waiting for data, or some operation to complete, another thread is allowed to run and complete useful work. When the instruction is complete, the thread that issued it is signaled, which causes that thread to be put in the ready state when it receives the signal. Context switching occurs only when an executing thread explicitly gives up control. The thread that has transitioned to the sleep state after executing and is waiting for a signal is, for all practical purposes, temporarily disabled (for arbitration) until the signal is received.

While illustrative target hardware is shown and described herein in some detail, it is understood that the exemplary embodiments shown and described herein for automatically generating code for performance evaluation are applicable to a variety of hardware, processors, architectures, devices, development systems/tools and the like.

In an exemplary embodiment, an architecture development tool is used to generate a visual diagram of an application. By representing tasks and other functions symbolically, a design can be examined to identify dependencies, evaluate performance, and consider resource allocations.

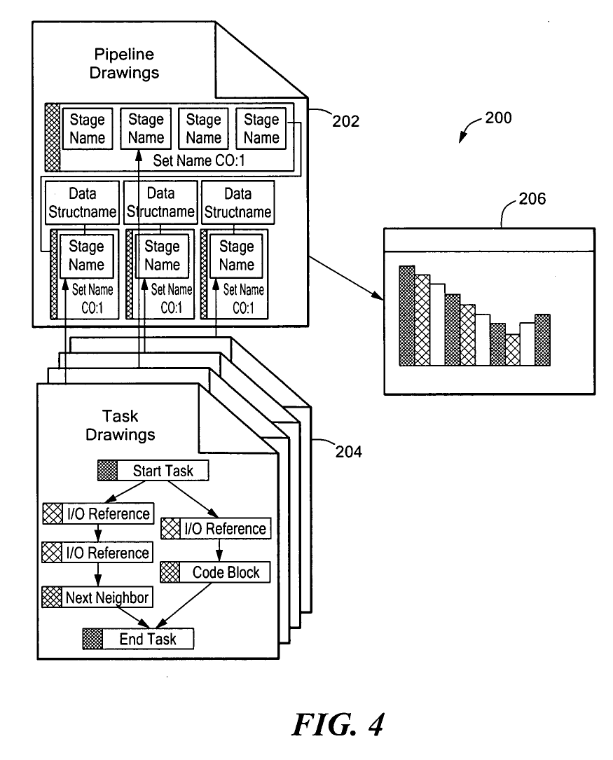

FIG. 4 shows an overview of an exemplary visualized project 200 generated by application architecture development tool for target hardware, such as the system 12 of FIG. 1. The architecture tool guides the user through the project design process and provides the user with an estimate of network processor performance. The resulting documentation describing the system generated by architecture tool can be used by a development/debug system to enable software developers to generate code to implement the design. In general, designing a project requires knowledge of the processing activities as well as the data structures that are referenced as the packets flow through the processor.

The processing requirements are divided into separate tasks that are assigned to pipe stages that are then mapped onto processing elements. Tasks are described by the following:
I/O References: Determine the loading imposed on the internal buses and external memory buses. I/O References are also used to determine the task execution time.
Next Neighbor communications: A next neighbor relationship is defined because they impose a requirement on the physical location of the PEs that the tasks are assigned to.
Code Blocks: Code blocks are used to determine the task execution time and PE utilization.
   A project is defined at a high level requiring knowledge of the processing requirements of the application being analyzed. Basic components of the project include visual representations of pipelines 202 and tasks 204 from which performance analysis information 206 can be obtained.

A pipeline drawing 202 provides a description of the pipeline and the mapping of the pipeline onto the processor. A task drawing 204 provides a high level description of the work performed in a task. Tasks are assigned to pipe stages. The task description includes the I/O references, next neighbor references, and code blocks. The analysis 206 of the pipeline drawing can provide memory space utilization, internal bus utilization, external memory bus utilization, task execution time, and PE utilization.

In an exemplary embodiment, functional and context pipelines can be modeled. In general, functional pipelines perform multiple tasks in order across one or more threads in one or more processing elements, such as the processing elements 20 of FIGS. 1 and 2. For simplicity, it can be assumed that functional pipelines are allocated to a whole number of processing elements completely, i.e., all the threads of one or more processing elements. Context pipelines perform a single task across multiple threads on the same processing element. A task in this case is a piece of processing logic that executes microcode instructions and possibly performs input/output (I/O)operations with other on-chip functional units.

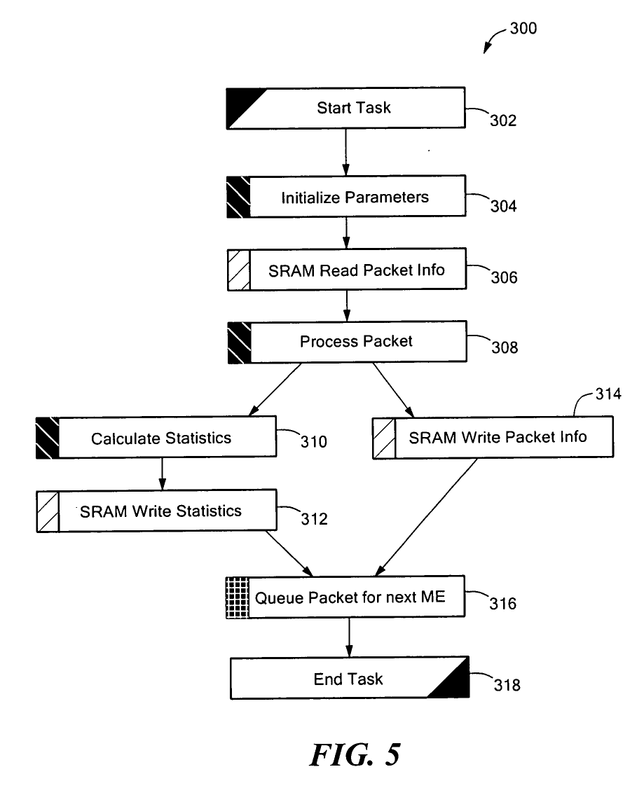

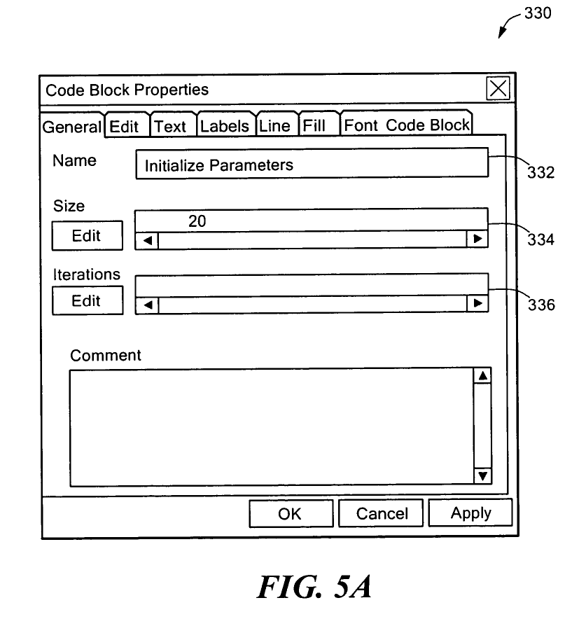

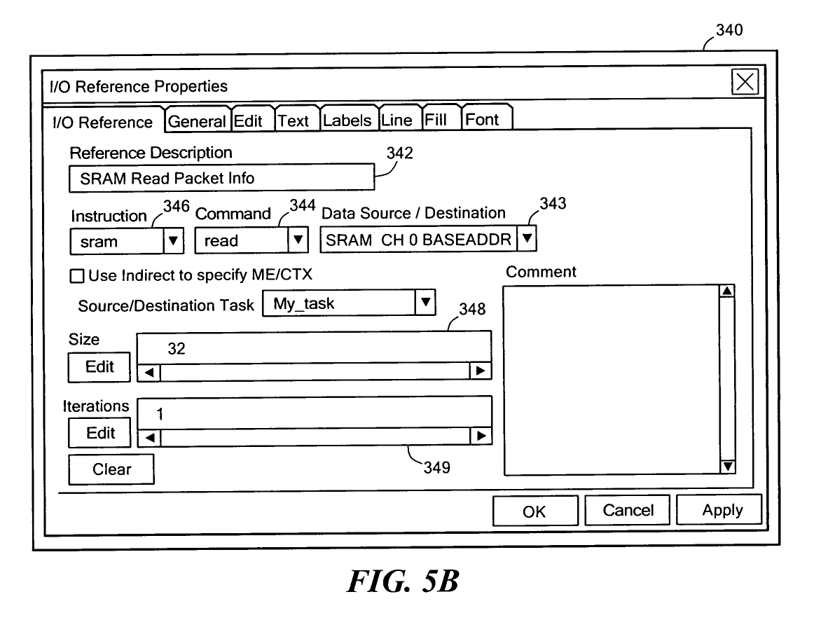

FIG. 5 shows an exemplary task drawing 300 directed to processing packets within a performance budget for given target hardware. The task includes various code blocks, I/O references and next-neighbor references with a start and end point. In the illustrated embodiment, the type (e.g., I/O reference, NN reference, code block) of each task portion is indicated with a respective symbol on the left side of the task segment. Code blocks represent an uninterrupted sequence of instructions executed on a processing element thread. I/O references are operations in which a functional unit external to a processing element is accessed that may require the processing element to halt execution of its code until the operation has completed. A next-neighbor operation references another processing element. Each code block, I/O reference and NN reference has associated attributes such as size, functional unit, operation, etc., described using dialog boxes.

In a first task segment 302, the task is started. Then in a first code block 304, parameters are initialized and in I/O reference block 306 packet information is read from SRAM. In a second code block 308, the packet is processed. From the second code block 308, processing can continue in parallel between a code block 310 to calculate statistics that are written to SRAM in I/O reference block 312 and an I/O reference 314 to write packet info to SRAM. After an I/O instruction, it is common to initiate a context switch and perform some type of processing, here calculating statistics in a code block 310, while waiting for a signal that the I/O operation is complete. In next neighbor (NN) block 316, a packet is queued for the next processing element and in block 318 the task ends.

The task drawing 300 represents the work performed in a pipe stage for a particular data stream. The task drawing identifies I/O references for the task and code blocks performed while processing the packets.

FIG. 5A shows an exemplary graphical user interface (GUI) 330 to enable a user to define a code block. Various characteristics, such as size, name etc., for the code block can be specified by the user. The GUI 330 includes a name field 332 into which the user can input a name for the code block, such as “initialize parameters.” The size, e.g., 20 instructions, of the code block can be input in a size field 334. And the number of iterations, e.g., 1, can be provided in an iteration field 336. The number of iterations can be defined as a variable.

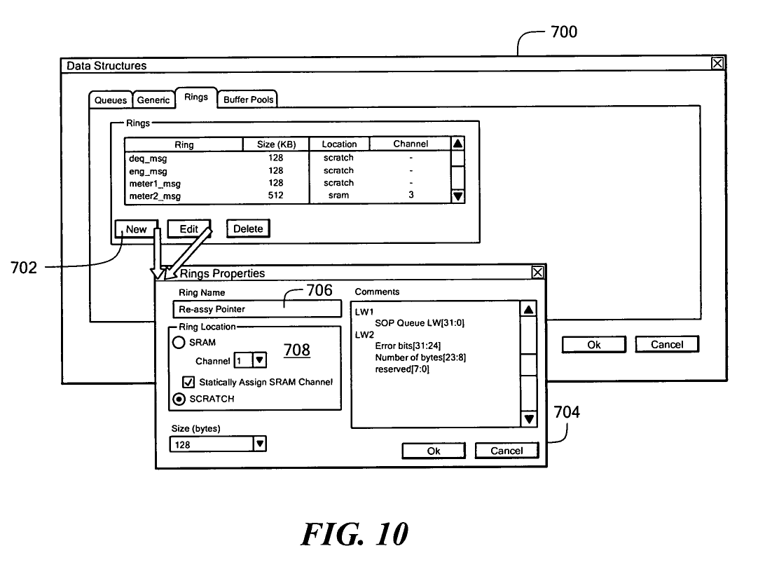

FIG. 5B shows a GUI window 340 to enable a user to define an I/O reference, such as the SRAM Read Packet Info 306 of FIG. 5, for which the code 450 can be automatically generated as shown in FIG. 10. The I/O reference GUI 340 includes a reference description field 342 and a data source/destination field 343, e.g., SARAM_CH_{—}0_BASEADDR. The data source/destination identifies the internal and external data buses affected by the I/O reference. The type of instruction, e.g., read, can be described in an instruction field 344 and a command type, e.g., read, can be defined in a command field 346. The size in bytes, e.g., 32, of the I/O reference can be defined in a size field 348. The number of iterations for the I/O reference can be input by the user in an iterations field 349, which can be conditional.

A NN reference can be defined in a similar manner as the code block and I/O reference.

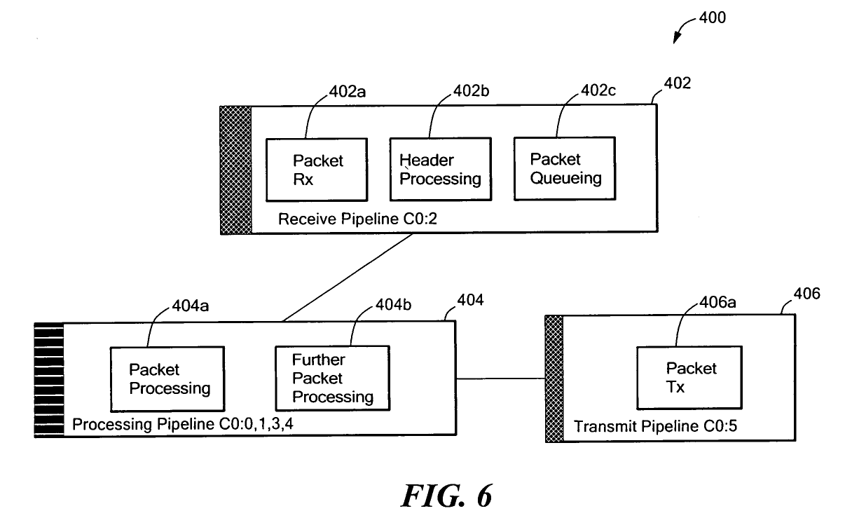

FIG. 6 shows a visual representation 400 of an exemplary packet processing pipeline of which the task 300 of FIG. 5 can form a part. A first dialog box 402 corresponds to a receive pipeline, which is a context pipeline, having a packet receive task 402a, a header processing task 402b, and a packet queuing task 402c. A second dialog box 404 corresponds to a packet processing pipeline, which is a functional pipeline. The packet processing pipeline 404 includes a packet processing task 404a and a further packet processing task 404b. The receive pipeline 402 provides a stream of data to the packet processing pipeline 404. A third dialog box 406 corresponds to a (context) packet transmit pipeline having a packet transmit task 406a.

The pipelines can include a reference to particular processing elements in particular clusters of processing elements. For example, CO:2 in the receive pipeline can refer to cluster 0, processing element 2.

Once the high-level project design is complete using the architecture tool, some performance analysis can be performed. If the performance is acceptable, the project file for the architecture tool can be provided to a software development system, which can have similar features and functionality as the Intel IXA SDK Workbench system. The development system first validates the project file from the architecture tool.

In an exemplary embodiment, the development system can automatically generate evaluation code from the project file of the architecture tool that can be used to examine performance for target hardware. The automatically generated code is not intended to implement a function but rather to execute instructions that should take a similar amount of processing load as the actual code to be developed later. For example, code blocks can have NOP instructions in place of actual instructions, which can be created later by the developer. A repeat loop is used to execute the desired number of NOP instructions that should take the same amount of time to execute as the later-developed code. By using a NOP block, a developer can evaluate code that will behave in a manner similar to the final code from a performance viewpoint, to provide early feasibility/performance testing.

Further details of an exemplary architecture development tool to design, document, and estimate performance of programs for the processing elements on network processing units, such as the IXP2400/IXP2800 Network Processor family (IXP2400/IXP2800), are set forth below. The architecture development tool embodiments allow a user to map an application onto a pipeline and evaluate design performance. The architecture tool can provide a graphical layout of the processing elements into a software pipeline and a graphical definition of the task performed by each of the processing elements in the pipeline. The tool can also provide performance information including memory utilization reporting, performance statistics reporting, and task execution time reporting.

In creating a project, a user defines data structures, tasks, and pipelines. The data structure definitions can be used to determine the total memory required for each memory interface and to verify that the data structures fit within the memory space limits. Each I/O reference defined in the tasks selects a data structure as a target. By assigning each data structure to a specific memory interface, bus utilization software can determine which memory interface should be taxed for the associated reference in the performance results. Exemplary data structure groupings include buffer pools (e.g., buffers, buffer descriptors, and queue links), queues, rings, and generic data structures.

In one embodiment, the user manually assigns data structures that reside in SRAM memory to a specific SRAM channel when the structure is defined. The user can allow the tool to optimize and reallocate them in an analysis window or the user can force a static assignment (the tool will not reallocate the data structure). The tool can reallocate the SRAM data structures to provide the best balance between memory capacity and the external SRAM bus utilization.

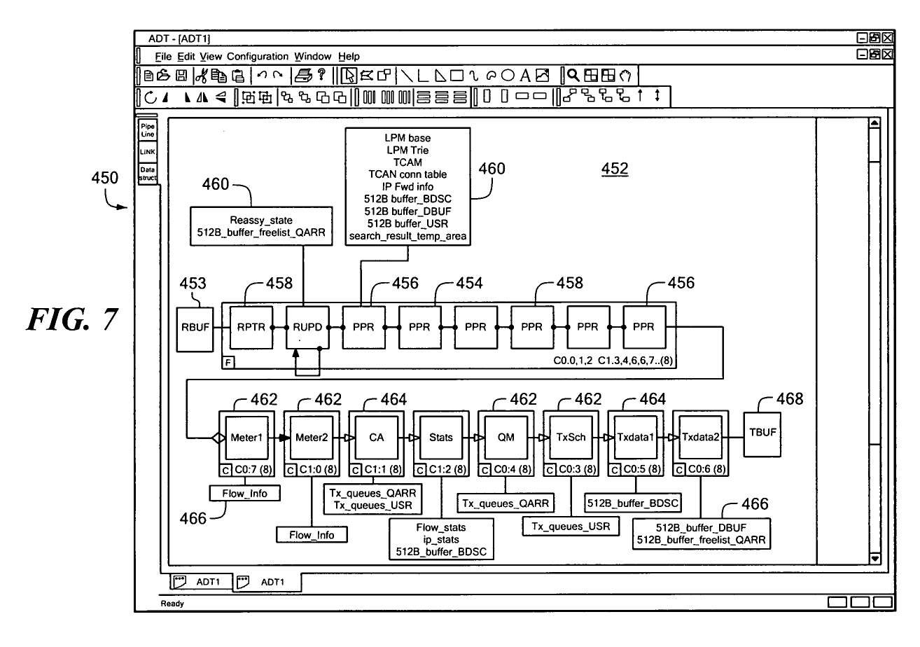

FIG. 7 shows an exemplary window 450 showing a visual design 452 of an illustrative application using an architecture development tool. The design 452 includes various symbols including a I/O reference 453, such as a receive buffer (RBUF) providing data to a first pipeline 454 having a series of processing elements 456 executing various tasks 458. Data structures 460 can be associated with certain tasks. The design 452 can include further processing elements 462 executing further tasks 464 having respective data structures 466 terminating in a I/O reference 468, such as TBUF.

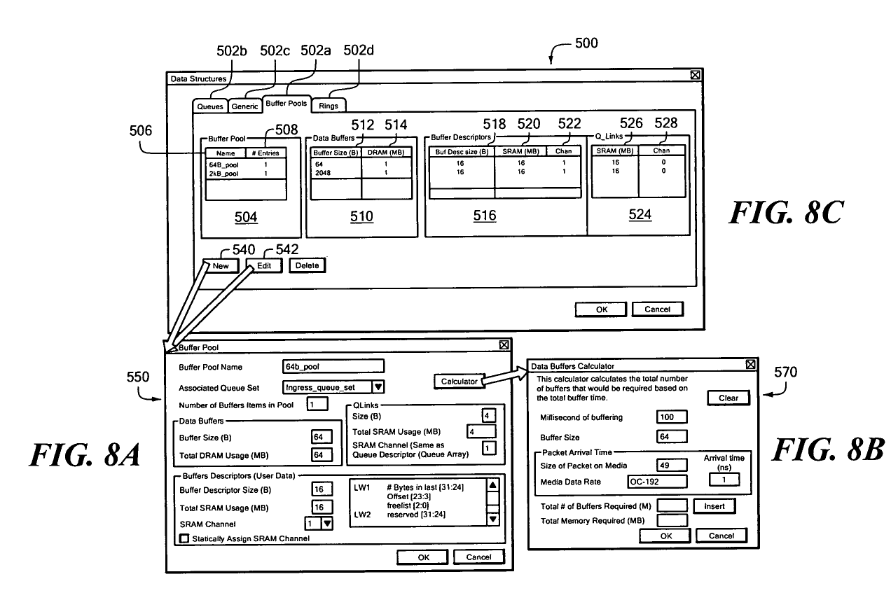

FIG. 8 shows an exemplary buffer pool window 500 that can be used to define buffer pools using a buffer pool tab 502a. Further tabs include queues 502b, generic 502c, and rings 502d. The buffer pools are called out as a group since:
number of buffers=number of buffer descriptors=number of queue links
The buffer pool window 500 includes a buffer pool section 504 having a list 506 of buffer names and associated number of entries 508. A data buffer section 510 includes a list 512 of buffer size and associated DRAM size 514. A buffer descriptor section 516 includes a buffer descriptor size 518, a SRAM size 520, and channel number 522. A queue link section 524 includes a SRAM size 526 and associated channel number 528.

The buffer pool window 500 can include a new button 540 to activate a buffer pool info window 550 as shown FIG. 8A below. An edit button 542 can be used to modify existing parameters for a given buffer pool. A delete button 544 can be used to delete a buffer pool.

For certain target hardware, there is a requirement that the queue links must reside in the same SRAM channel as the queue descriptor (queue array) to which they are associated. So at least one queue descriptor (queue array) must be defined before the user is allowed to create a buffer pool. The queue descriptor (queue array) is defined in the queues tab 502b.

When defining a buffer pool, it is assumed that the buffer pool resides in DRAM memory. Multiple buffers pools are supported and therefore a name is assigned to each pool. The parameter relationship is as follows.
Total_dram_size=Number_of_buffers*buf_size

FIG. 8A shows a buffer pool info window 550 that can be launched by activating the new or edit button 540, 542 in FIG. 7. The info window 550 includes various exemplary fields including buffer pool name 552, associated queue set 554, buffer size 556, and buffer descriptor size 558.

FIG. 8B shows an exemplary data buffer calculator window 570 that can help the user determine the number of buffers required based on the number of milliseconds of buffering required. The window calculates the following:
Arrival_time=pkt_size*8 bytes/bit*(1/data_rate)
Number_of_buffers=(arrival_time)*(pkt_size)*(1/buff_size)* (1/buffer_time)
Total_memory=Number_of_buffers*buff_size)
It is assumed that each buffer has a buffer descriptor associated with it that contains user defined data (If this is not the case the size can be set to 0). This means:
Number_of_buffers=Number_of buffer_desc
The user then selects the size of a descriptor (which is assumed to be the same for all buffers) and the SRAM channel in which the buffer descriptor resides. The tool then calculates the total SRAM used as follows:
Total_memory=Number_of_buffers*buff_desc_size

It is assumed that each buffer descriptor will be enqueued onto a queue using the hardware queuing support provided in the network processor. This implies that there is a QLink that is associated with each buffer descriptor that must reside in the same SRAM channel as the queue descriptor set (head, tail, count). This forces the channel selection for the queue descriptor set to be the same as the associated queue. The QLinks are four bytes and the total SRAM used is:
Total_memory=(Number_of_buffers*4)

For target hardware that has hardware support for queuing, such as the IXP2400/IXP2800 network processors, the queues descriptors can be broken out separately. Exemplary requirements include:
Memory must be allocated for each queue for the queue descriptor set (head, tail, count).
This data must reside in the same SRAM channel as the QLinks.
The minimum size of the queue descriptor set is 12 bytes (3LW). Optional data can be read by setting the ref_cnt in the instruction to 3 or greater. These must also reside in the same channel.

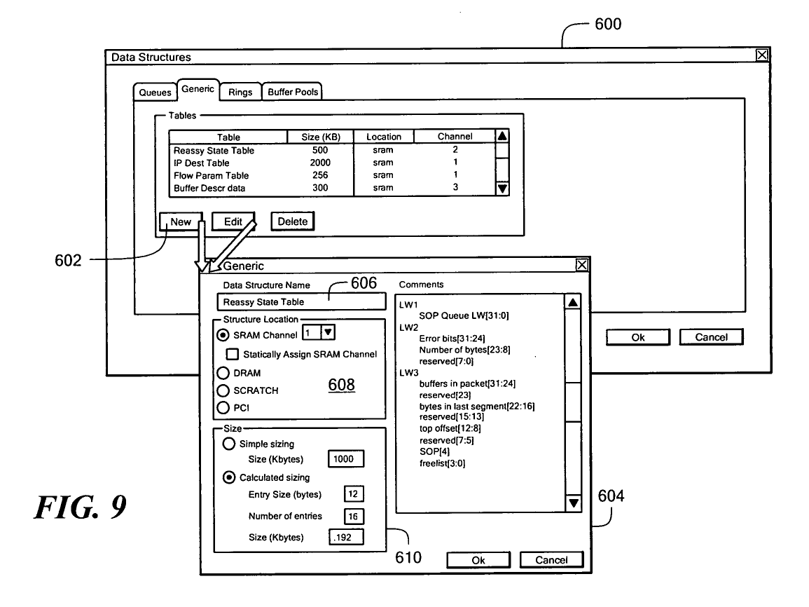

As shown in FIG. 9, a user can also specify generic data structures in a generic data structure window 600. New data structures are defined by pressing the new button 602 that opens the data structure dialog box 604. The user specifies a name 606 and location 608 where the data structure resides (SRAM, DRAM or Scratch). If SRAM is selected the user specifies the channel number.

The size 610 of the data structure can be selected one of two ways: 1) simple sizing which allows the user to define it as a simple block of memory; and 2) calculated sizing that allows the user specify the size of a data structure element and then specify the number of elements.

FIG. 10 shows a ring data structure window 700 through which a user can input ring data. In some target hardware, such as the IXP2400/IXP2800 processor, there is hardware support for rings in SRAM and scratch memory. By explicitly defining the structure as a ring the exemplary architecture development tools can determine whether more rings have been allocated that the hardware supports.

The user can define a new ring by pressing the new button 702. In a dialog box 704, the user is asked to enter a name 706 for the ring. After the name is specified, the ring dialog box is opened with the new ring name selected in the ring name box. The user specifies the location 708 the data structure resides (SRAM, or Scratch).

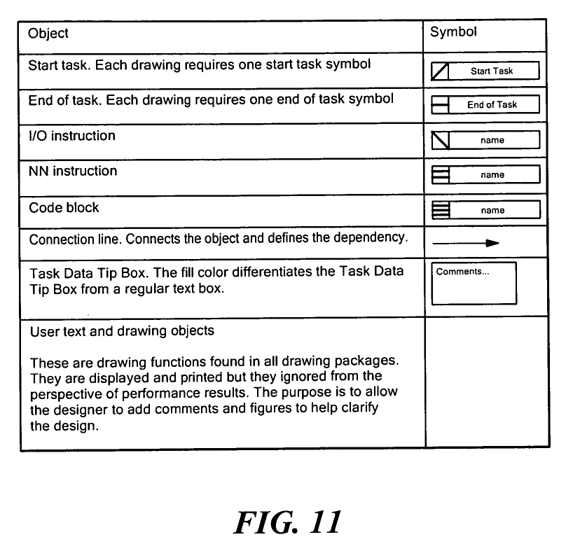

As described above, a task drawing defines I/O instructions, next neighbor instructions, and code blocks that are executed for a packet. Task drawings identify the references that are performed when a processing engine processes a packet and provides an easy way for identifying the code paths and reducing the possibility of errors. In addition, the task drawings identify the code path that incurs the longest latency. This is compared to the execution time budget allotted which is based on the packet arrival time, the chip clock frequencies, and the number of processing elements in the pipe stage. In general, objects are dropped on the task page and assigned properties. Exemplary supported objects are shown in FIG. 11.

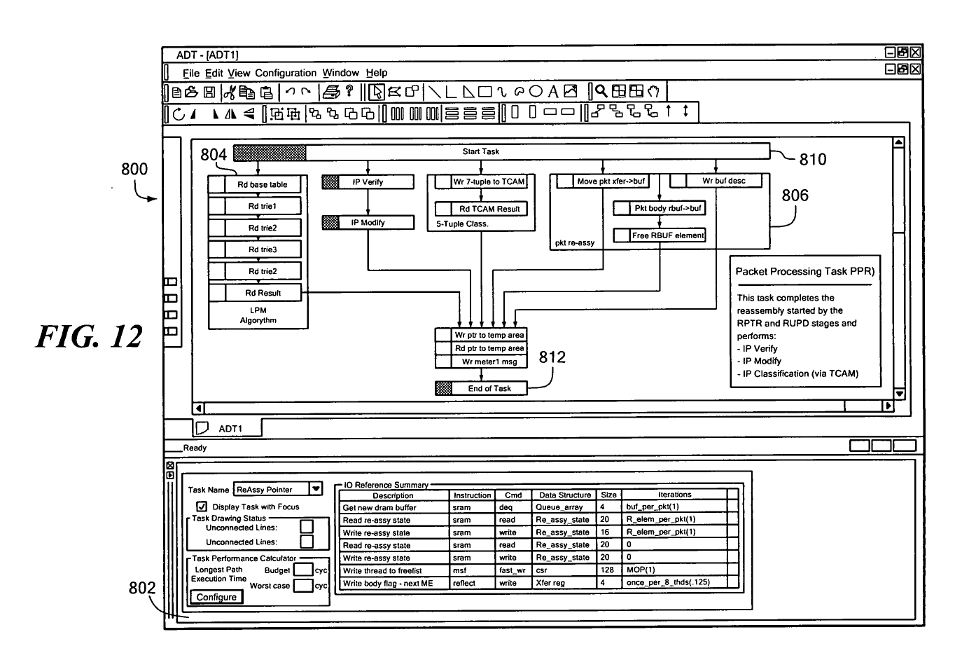

FIG. 12 shows an exemplary task window 800 and task definition window 802. An exemplary task, e.g., ADT1, is defined for a packet processing pipe stage. The task definition window 802 enables a user to see a summary of the operations performed by the task ADT1. In addition, when the user defines a variable or conditional, the user can view the value in addition to the variable name or the conditional definition.

The task ADT1 comprises multiple functions that result in different execution paths, in this case a LPM IP destination search 804, 5-Tuple Classification 806, and packet reassembly 808. Path dependencies begin and end with the start of task 810 and end with end of task 812. Each object is connected with an arrowed line that indicates the direction of the dependencies.

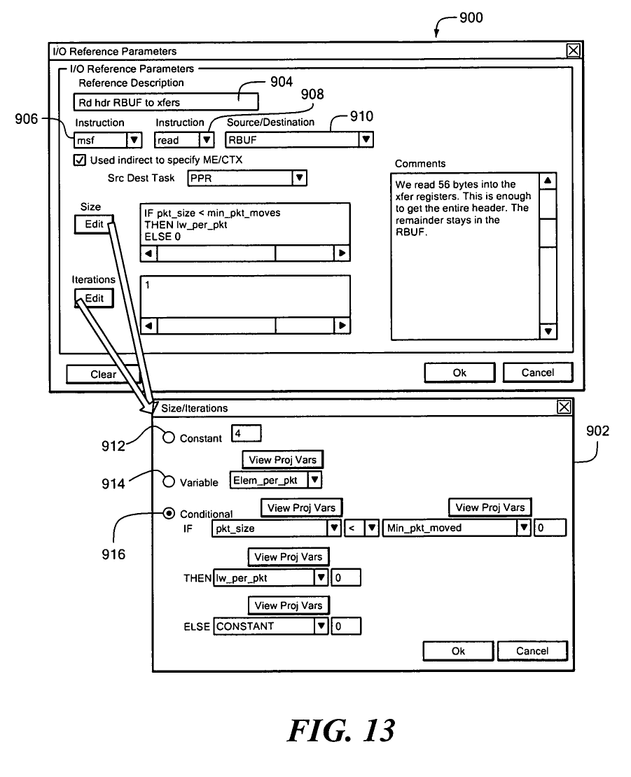

FIG. 13 shows an exemplary I/O Reference property window 900 and size/iteration window 902. The I/O reference property window 900 is displayed when an I/O reference is dropped onto a task page or the user right clicks on an I/O reference object and selects “Properties”. The Reference Description 904 is a textual description of the reference. The instruction 906, command 908, and source/destination boxes 910 are used to identify the internal and external buses that are affected by the I/O reference. An I/O reference is targeted toward source/destination. Source/destination includes user defined data structures as well as a generic hardware structure.

The size can be set to a constant 912, variable 914, or conditional 916 in the size/iteration box 902. Variables are useful, for example, in the case where a burst size may change depending on the size of the packet. Iteration indicates the number of times to perform the instruction per packet. For example large packets may require multiple DRAM[rbuf_rd] instructions. The variable option allows a user to have the tool calculate the number of iterations based on, for example, the size of the packet. Another case is to specify the number of iterations as a fractional value. For example, writing a statistic to memory may occur once every “n” packets.

The conditional option 916 allows the command to be included or excluded from the performance results based on a condition. For example, for a 40 byte IP packet, all the data might be written into the buffer from the PE rather than the RBUF. In this case, the conditional would be placed on the dram[rbufjrd] would be (packet_size>=40 bytes).

Source/Destination 910 options include: TBUF, RBUF, CSR, or a data structure name. This information is useful to determine what memory units (dram, specific sram channel 0-3, or scratch) to tax for during the bus utilization analysis. The TBUF, RBUF, PCI MEMORY, and CSRs are descriptive way of saying that memory should not be taxed.

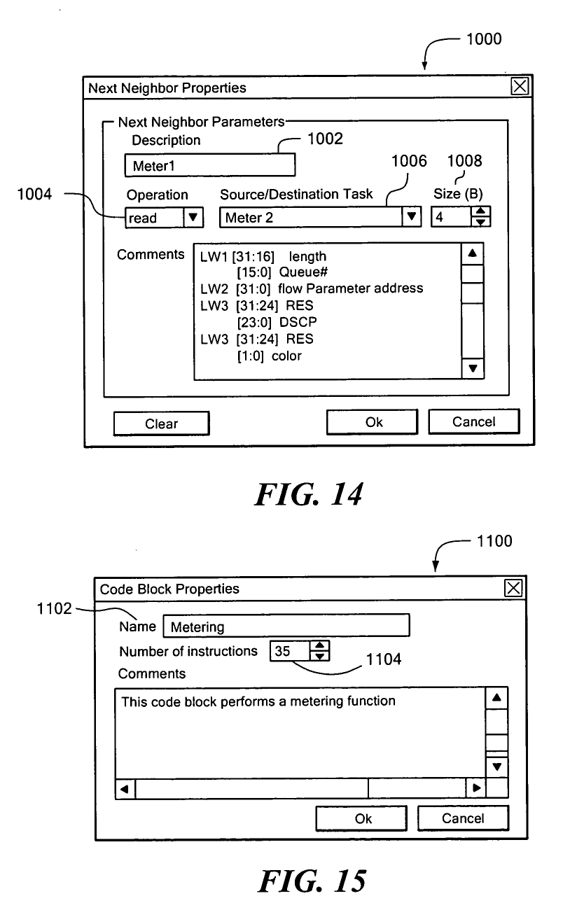

FIG. 14 shows an exemplary next neighbor property window 1000 displayed when a next neighbor object is dropped onto a task page. Next neighbor relationships are defined so that the relationship between pipe stages can be accurately drawn on the pipeline drawing and so that the tool can verify that tasks are defined with matching NN operations. As described above, each PE has two next neighbor interfaces (except PE 0 and 15 in a 16 PE unit), one with the previous PE, and another with the next PE.

A description box 1002 contains the name and an operation list box 1004 indicates whether the next neighbor register operation is a get or put, or read or write. If get or put are specified, it is implied that the next neighbor registers are configured as a ring. If read or write are specified, it is implied that the next neighbor registers are configured as context relative. A Source/Destination list box 1006 specifies the name of the task to which the next neighbor operation is targeted and a size box 1008 indicates the size of the message passed between the tasks.

FIG. 15 shows an exemplary code block property window 1100 displayed when a code block object is dropped onto a task page. The code block property 1100 identifies the name 1102 and the number of instructions 1104 in the code block.

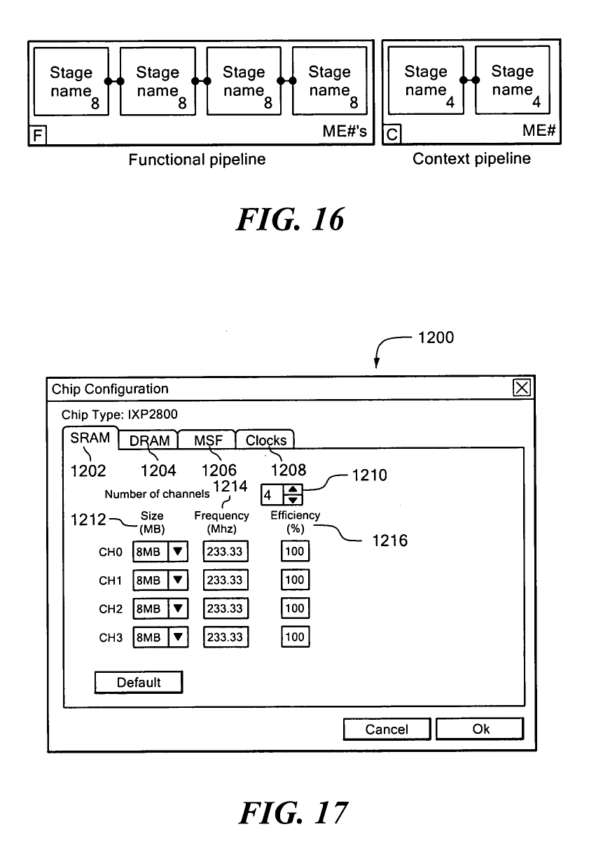

As shown in FIG. 16, a pipeline object represents one or more context or functional pipe stages. A context pipe stage executes in a single PE, however multiple context pipe stages can execute in the same PE. A Functional pipe stage executes on two or more PEs. A shaded box around the pipe stage pipeline object can be viewed as a grouping of pipe stages that execute in a physical PE. The PE No., shown as CO:4(8), for example, in the shaded box designates the specific PE(s). Functional pipe stages list two or more PEs in the PE No. field while context pipe stages specify a single PE. The PEs are identified by a cluster number, e.g., C0, and an ME number and are displayed on the pipeline object. If two (or more) pipe stages in a functional pipeline are assigned the same task, it is assumed that the one task is preformed over two (or more) pipe stage times and the task is analyzed once.

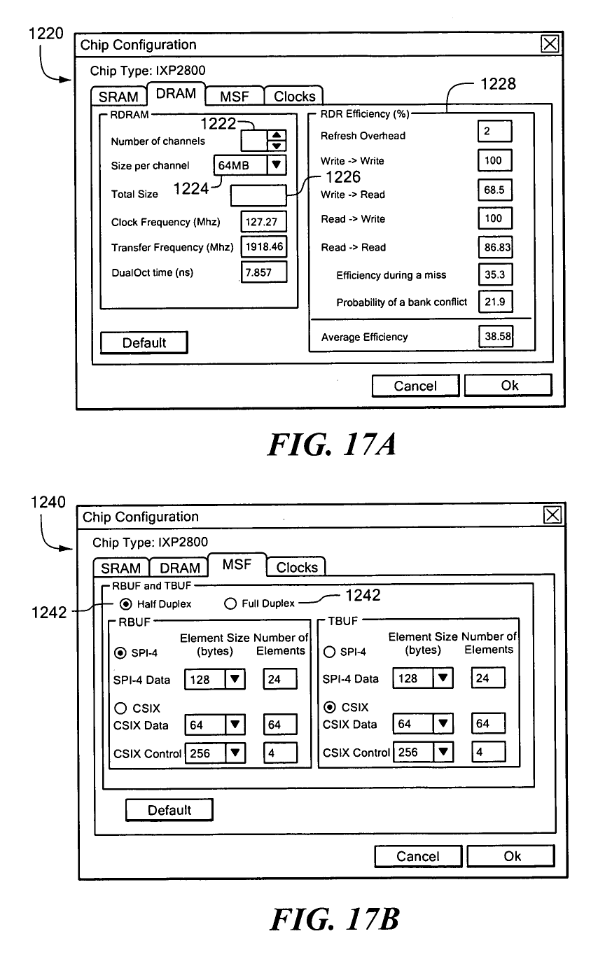

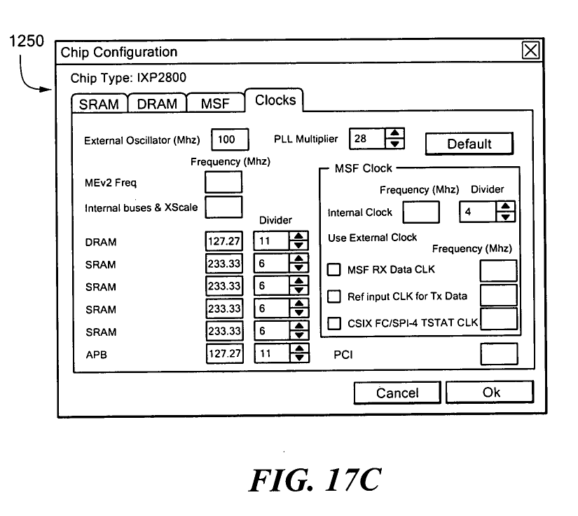

FIG. 17 shows an exemplary chip configuration window 1200 for an exemplary IXP2800 processor. Four chip configurations include SRAM 1202, DRAM 1204, MSF 1204, and Clocks 1206. The SRAM tab 1202 allows the user to configure the number of SRAM channels 1210 that are enabled (e.g., 0 to 4) with illustrative size options 1212 of 1 MB, 2 MB, 3 MB, 4 MB, 6 MB, 8 MB, 12 MB, 16 MB, 24 MB, 32 MB, 48 MB, 64 MB per channel. The frequency 1214 is set on the clocks tab and is displayed here for reference. The efficiency 1216 can be set from 0 to 100.

The DRAM tab 1220 shown in FIG. 17A allows the user to configure the number of DRAM channels 1222. The Size Per Channel 1224 is selectable by user and can be 8 MB, 16 MB, 32 MB, 64 MB, 128 MB, 512 MB, 1 GB. The total size 1226 is calculated as “Size Per Channel”×“Number of Channels.”

The efficiency 1228 of the DRAM controller can be calculated as follows:
Read→Read=(1−prob. of bank conflict)+(Efficiency during a miss+prob. of bank conflict)
Average efficiency=((Read→Read+Write→Write+Write→Read+Read→Write)/4)−Refresh overhead
The Average efficiency is multiplied by total budgeted DRAM cycles per packet for the performance results.

A MSF (media switch fabric) tab 1240 shown in FIG. 17B enables the user to select half duplex 1242 or full duplex 1244 operation for receive buffering (RBUF) and transmit buffering (TBUF). In addition, various characteristic of the RBUF and TBUF can be selected, as shown, such as buffer partitioning.

The clocks tab 1250 shown in FIG. 17C enables the user to specify the clocks for the chip using the same methodology as the hardware. Note that some clocks specified are not used by ADT.

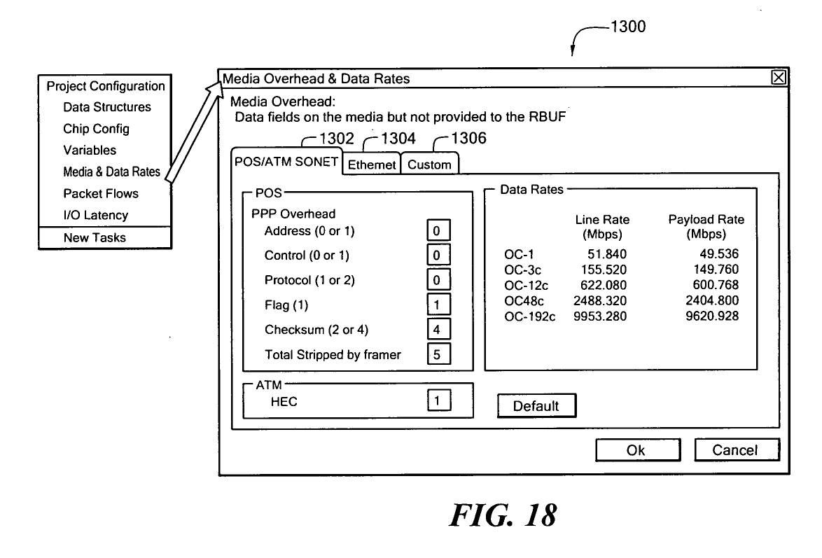

FIG. 18 shows an exemplary Media Overhead & Data Rate window 1300 defining the settings for the media interfaces. Illustrative supported media types include SONET (ATM and POS) 1302, Ethernet 1304, and custom 1306. The media overhead is used in the calculation of the packet arrival time and is based on bits that are present on the media wire but stripped prior to passing the packet onto the network processor and inter packet gap time.
packet_arrival_time=((size_of media_overhead+size_of pkt_in_rbuf)* 8 bits/byte)/data_rate

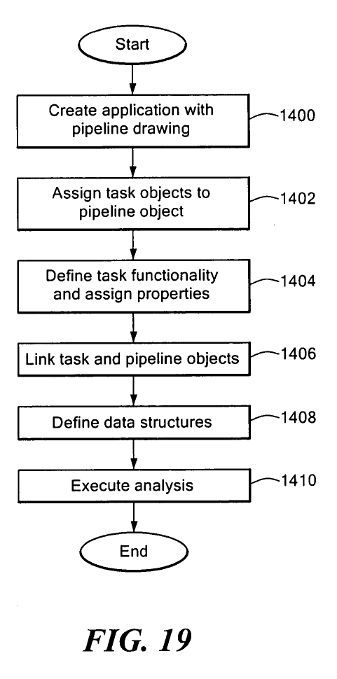

FIG. 19 shows an exemplary processing sequence to generate a visual design using an architecture development tool. In processing block 1400, a user creates an application including at least one pipeline drawing having one or more pipeline objects and in processing block 1402 assigns task objects, such as I/O references, next neighbor instructions and code blocks, to the pipeline drawing. The various task objects are functionally defined in processing block 1404 and properties are assigned to the tasks. Code paths to define possible execution paths can also be defined. The objects are linked together in processing block 1406. In processing block 1408, a user defines data structures, such as buffer pools, queues, rings and generic data structures used by the application. Analysis of the design can be performed in processing block 1410.

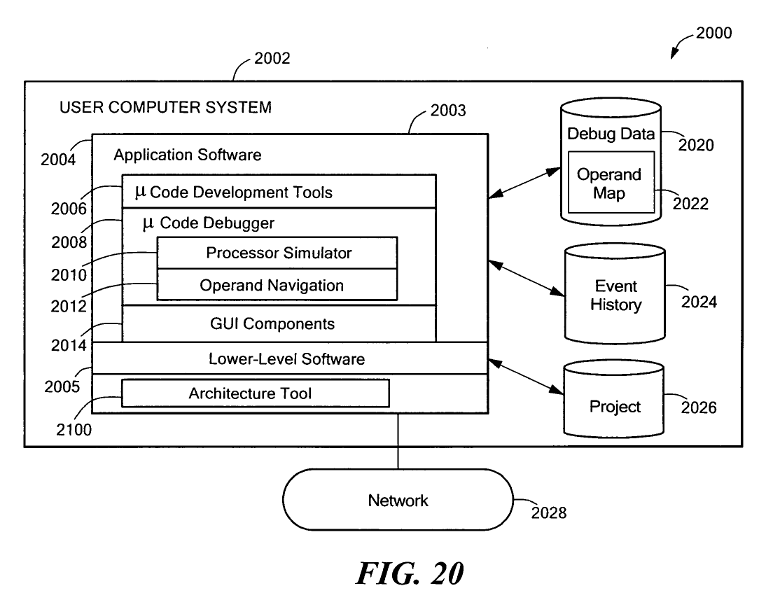

FIG. 20 shows a system 2000 that can include an architecture development tool and a development/debugger tool. The system 2000 includes a user computer system 2002 that enables a user to design an architecture for an application to run on target hardware and to develop/process/debug microcode that is intended to execute on one or more processing elements of the target hardware. In one embodiment, the processing element is the PE 20, which may operate in conjunction with other PEs 20, as shown in FIGS. 1-2.

Software 2003 includes both upper-level application software 2004 and lower-level software (such as an operating system or “OS”) 2005. The application software 2004 includes an architecture design tool 2100 and microcode development tools 2006 (for example, in the example of processor 12, a compiler and/or assembler, and a linker, which takes the compiler or assembler output on a per-PE basis and generates an image file for all specified PEs). The application software 2004 further includes a source level microcode debugger 2008, which include a processor simulator 2010 (to simulate the hardware features of processor 12) and an Operand Navigation mechanism 2012. Also included in the application software 2004 are GUI components 2014, some of which support the Operand Navigation mechanism 2012. The Operand Navigation 2012 can be used to trace instructions.

Still referring to FIG. 20, the system 2002 also includes several databases. The databases include debug data 2020, which is “static” (as it is produced by the compiler/linker or assembler/linker at build time) and includes an Operand Map 2022, and an event history 2024. The event history stores historical information (such as register values at different cycle times) that is generated over time during simulation. The project database 2026 contains project pipeline and task design information. The system 2002 may be operated in standalone mode or may be coupled to a network 2028 (as shown).

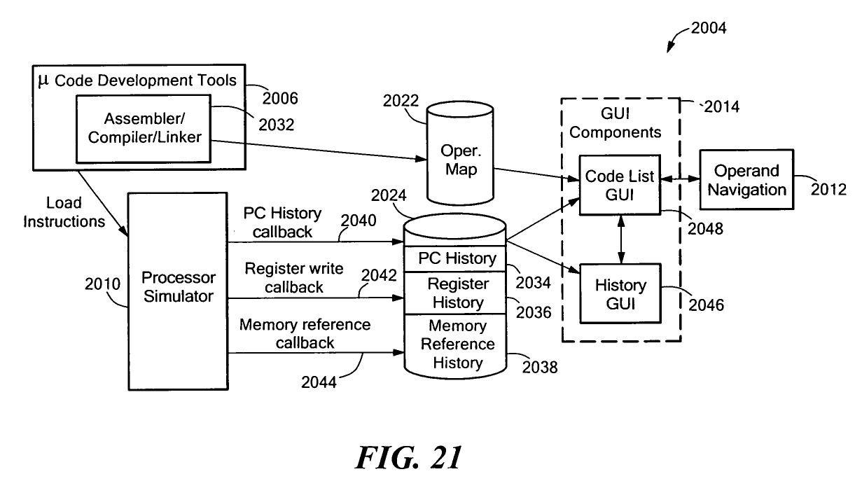

FIG. 21 shows a more detailed view of the various components of the application software 2004 for the system of FIG. 20. They include an assembler and/or compiler, as well as linker 2032; the processor simulator 1010; the event history 2024; the (Instruction) operation map 2026; GUI components 2014; and the operand navigation process 2012. The event history 2024 includes a thread (context)/PC History 2034, a register history 2036 and a memory reference history 2038. These histories, as well as the operand map 2022, exist for every PE 20 in the processor 12.

The assembler and/or compiler produce the operand map 2022 and, along with a linker, provide the microcode instructions to the processor simulator 2010 for simulation. During simulation, the processor simulator 2010 provides event notifications in the form of callbacks to the event history 2024. The callbacks include a PC history callback 2040, a register write callback 2042 and a memory reference callback 2044. In response to the callbacks, that is, for each time event, the processor simulator can be queried for PE state information updates to be added to the event history. The PE state information includes register and memory values, as well as PC values. Other information may be included as well.

Collectively, the databases of the event history 2024 and the operand map 2022 provide enough information for the operand navigation 2012 to follow register source-destination dependencies backward and forward through the PE microcode.

The system 2002 of FIG. 20 can generate evaluation code based upon the design visually generated by the architecture development tool to examine performance on target hardware. The task 300 of FIG. 5 can provide an example for which code can be automatically generated and evaluated.

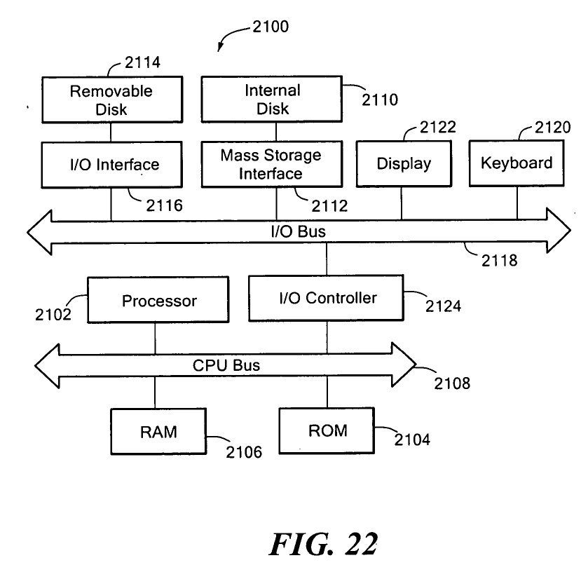

Referring to FIG. 22, an exemplary computer system 2100 suitable for use as an architecture development tool and development/debugger tool is shown. The architecture development tool and/or development tool/assembler may be implemented in a computer program product tangibly embodied in a machine-readable storage device for execution by a computer processor 2102; and methods may be performed by the computer processor 2102 executing a program to perform functions of the tool by operating on input data and generating output.

Suitable processors include, by way of example, both general and special purpose microprocessors. Generally, the processor 2102 will receive instructions and data from a read-only memory (ROM) 2104 and/or a random access memory (RAM) 2106 through a CPU bus 2108. A computer can generally also receive programs and data from a storage medium such as an internal disk 2110 operating through a mass storage interface 2112 or a removable disk 2114 operating through an I/O interface 2116. The flow of data over an I/O bus 2118 to and from devices 2110, 2114, (as well as input device 2120, and output device 2122) and the processor 2102 and memory 2106, 2104 is controlled by an I/O controller 2124. User input is obtained through the input device 2120, which can be a keyboard, mouse, stylus, microphone, trackball, touch-sensitive screen, or other input device. These elements will be found in a conventional desktop computer as well as other computers suitable for executing computer programs implementing the methods described here, which may be used in conjunction with output device 2122, which can be any display device (as shown), or other raster output device capable of producing color or gray scale pixels on paper, film, display screen, or other output medium.

Storage devices suitable for tangibly embodying computer program instructions include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

Typically, processes reside on the internal disk 2110. These processes are executed by the processor 2102 in response to a user request to the computer system's operating system in the lower-level software 105 after being loaded into memory. Any files or records produced by these processes may be retrieved from a mass storage device such as the internal disk 2110 or other local memory, such as RAM or ROM.

The system illustrates a system configuration in which the application software is installed on a single stand-alone or networked computer system for local user access. In an alternative configuration, e.g., the software or portions of the software may be installed on a file server to which the system is connected by a network, and the user of the system accesses the software over the network.

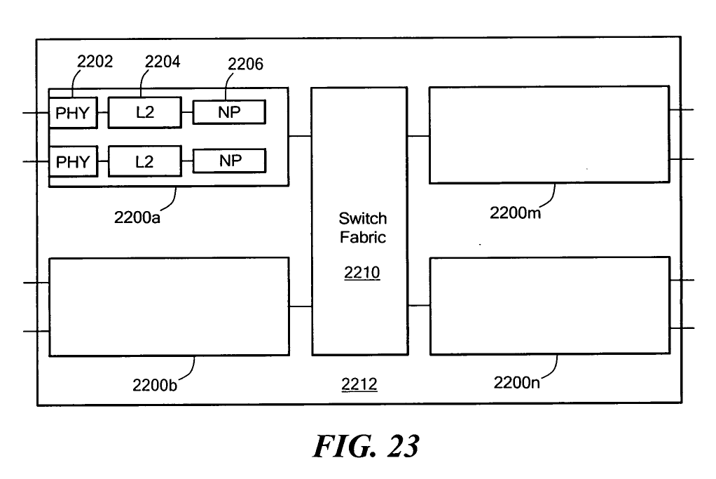

FIG. 23 depicts a network forwarding device that can include a network processor having microcode produced from a design generated by an architecture development tool. As shown, the device features a collection of line cards 2200 (“blades”) interconnected by a switch fabric 2210 (e.g., a crossbar or shared memory switch fabric). The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., 2200a) may include one or more physical layer (PHY) devices 2202 (e.g., optic, wire, and wireless PHYs) that handle communication over network connections. The PHYs translate between the physical signals carried by different network mediums and the bits (e.g., “0”-s and “1”-s) used by digital systems. The line cards 2200 may also include framer devices (e.g., Ethernet, Synchronous Optic Network (SONET), High-Level Data Link (HDLC) framers or other “layer 2” devices) 904 that can perform operations on frames such as error detection and/or correction. The line cards 2200 shown may also include one or more network processors 2206 that perform packet processing operations for packets received via the PHY(s) 2202 and direct the packets, via the switch fabric 2210, to a line card providing an egress interface to forward the packet. Potentially, the network processor(s) 2206 may perform “layer 2” duties instead of the framer devices 2204.

While FIGS. 1, 2, and 3 describe specific examples of a network processor and a device incorporating network processors, the code generation techniques described herein may be implemented in a variety of circuitry and architectures including network processors and network devices having designs other than those shown. Additionally, the techniques may be used in a wide variety of network devices (e.g., a router, switch, bridge, hub, traffic generator, and so forth).

The term circuitry as used herein includes hardwired circuitry, digital circuitry, analog circuitry, programmable circuitry, and so forth. The programmable circuitry may operate on computer programs.

Other embodiments are within the scope of the following claims.

What is claimed is:

1. A method of producing a graphical representation of a design for a processor system: having a plurality of processing elements, comprising:
displaying a pipeline object defined by a user; and
storing a first task object having at least one object of an I/O instruction, a next neighbor instruction and a code block, wherein the first task object is associated with the pipeline object.

2. The method according to claim 1, wherein the first task object has multiple execution paths.

3. The method according to claim 1, wherein the first task object is to be executed by a first one of a plurality of processing elements.

4. The method according to claim 1, further including storing a data structure associated with the I/O instruction.

5. The method according to claim 4, wherein the data structure includes one or more of a buffer pool, a queue, a ring, and a generic data structure.

6. The method according to claim 1, further including storing properties for the I/O reference.

7. The method according to claim 6, wherein the properties of the I/O reference include at least one of a source/destination and instruction.

8. The method according to claim 1, further including storing properties for the next neighbor instruction.

9. The method according to claim 1, further including storing properties for the code block instruction.

10. The method according to claim 9, wherein the properties for the code block instruction include a number of instructions.

11. The method according to claim 1, further including representing processing elements by processing element objects configured as a pipe stage selected as a first one of a functional pipe stage and a context pipe stage.

12. The method according to claim 11, further including receiving assignments of tasks to the processing element objects.

13. The method according to claim 1, further including analyzing performance of the design.

14. The method according to claim 1, wherein analyzing performance includes providing information for one or more of memory utilization, pipeline performance, and bus bandwidth performance.

15. The method according to claim 1, wherein the pipeline object is a first one of a functional pipeline and a context pipeline.

16. An article comprising:
a storage medium having stored thereon instructions that when executed by a machine, which is capable of producing a graphical representation of a design for a processor system having a plurality of processing elements, result in the following:
displaying a pipeline object defined by a user; and
storing a first task object having at least one object of an I/O instruction, a next neighbor instruction and a code block, wherein the first task object is associated with the pipeline object.

17. The article according to claim 16, wherein the first task object has multiple execution paths.

18. The article according to claim 16, further including storing a data structure associated with the I/O instruction.

19. The article according to claim 18, wherein the data structure includes one or more of a buffer pool, a queue, a ring, and a generic data structure.

20. The article according to claim 16, further including instructions to analyze performance of the design.

21. The article according to claim 20, wherein analyzing performance includes providing information for one or more of memory utilization, pipeline performance, bus bandwidth performance.

22. A system, comprising:
a processor;
a memory coupled to the processor to store instructions that when executed by the processor enable a user to produce a graphical representation of a design for a processor system having a plurality of processing elements by:
displaying a pipeline object defined by a user; and
storing a first task object having at least one object of an I/O instruction, a next neighbor instruction and a code block, wherein the first task object is associated with the pipeline object.

23. The system according to claim 22, wherein the first task object has multiple execution paths.

24. The system according to claim 22, further including storing a data structure associated with the I/O instruction.

25. The system according to claim 24, wherein the data structure includes one or more of a buffer pool, a queue, a ring, and a generic data structure.

26. The system according to claim 22, further including instructions to analyze performance of the design.

27. The system according to claim 26, wherein analyzing performance includes providing information for one or more of memory utilization, pipeline performance, bus bandwidth performance.

28. A network forwarding device, comprising:
at least one line card to forward data to ports of a switching fabric;
the at least one line card including a network processor having multi-threaded microengines configured to execute microcode, wherein the microcode comprises a microcode developed using a system that
displayed a pipeline object defined by a user; and
stored a first task object having at least one object of an I/O instruction, a next neighbor instruction and a code block, wherein the first task object is associated with the pipeline object.

29. The device according to claim 28, wherein the first task object has multiple execution paths.

30. The device according to claim 28, wherein the system stored a data structure associated with the I/O instruction.
